(19) United States
(12) Patent Application Publication
(10) Pub. No.: US 2026/0291719 A1
(43) Pub. Date: Sep. 24, 2026

(54) MEMORY UNIT AND DATA PROCESSING METHODS FOR COMPRESSED STORAGE OF INFORMATION IN SUPERPOSITION

(71) Applicant: International Business Machines Corporation, Armonk, NY (US)

(72) Inventors: Athanasios Vasilopoulos, Zurich (CH); Patrick Diener, Zurich (CH); Abbas Rahimi, Zurich (CH); Abu Sebastian, Adliswil (CH)

(21) Appl. No.: 19/088,961

(22) Filed: Mar. 24, 2025

(51) Int. Cl. H04L 9/08

(52) U.S. Cl. CPC H04L 9/0861

(57) ABSTRACT

A key is generated for each vector of a plurality of vectors to be stored. Each vector of the plurality of vectors is bound with the corresponding key to create a 2-dimensional distributed representation via an outer product operation. The 2-dimensional distributed representation is put in a superposition with another 2-dimensional distributed representation to create an aggregated 2-dimensional distributed representation. The aggregated 2-dimensional distributed representation is stored in an in-memory compute unit. A retrieval key of the plurality of keys corresponding to a requested vector is requested and the retrieval key corresponding to the requested vector is generated. The retrieval key is used to retrieve the requested vector from the stored aggregated 2-dimensional distributed representation.

### BACKGROUND

The present invention relates generally to the electrical, electronic, and computer arts and, more particularly, to machine learning and in-memory computing.

With the rise of data intensive applications, like machine learning, a new paradigm of computing has emerged. Conventional computing is limited by the continuous shuffle of data between memories and processing units, also known as the “Von Neumann bottleneck.” The new paradigm, called in-memory computing (IMC), attempts to circumvent that bottleneck by performing computation inside the memory, where the data exists. The most promising IMC paradigm is the one that uses non-volatile memory (NVM) devices, such as memristors or Flash, due to their increased efficiency compared to volatile technologies, such as static random-access memory (SRAM) and dynamic random-access memory (DRAM). The memory arrays built for IMC allow for concurrent activation of multiple rows and columns in parallel, attempting to use circuit laws to perform multiplications and additions. In its most basic form, an IMC device can perform matrix-vector multiplications, a highly pertinent operation in machine learning, fully in parallel by activating all rows and all columns in a specifically designed memory array.

### BRIEF SUMMARY

Principles of the invention provide techniques for memory unit and data processing methods for compressed storage of information in superposition. In one aspect, an exemplary method includes the operations of generating a key for each vector of a plurality of vectors to be stored; binding each vector of the plurality of vectors with the corresponding key to create a 2-dimensional distributed representation via an outer product operation; putting the 2-dimensional distributed representation in a superposition with another 2-dimensional distributed representation to create an aggregated 2-dimensional distributed representation; storing the aggregated 2-dimensional distributed representation in an in-memory compute unit; requesting a retrieval key corresponding to a requested vector of the plurality of keys; generating the retrieval key corresponding to the requested vector; and using the retrieval key to retrieve the requested vector from the stored aggregated 2-dimensional distributed representation.

In one aspect, a circuit comprises a key generator configured to generate a key; a memory unit comprising a matrix of in-memory compute units and configured to store an aggregated 2-dimensional distributed representation of a plurality of vectors; a plurality of digital-to-analog converters coupled to the key generator and coupled to the memory unit, and configured to convert a digital value of the key to a set of analog signals, each analog signal configured to drive a corresponding row of the matrix; a plurality of analog-to-digital converters coupled to the memory unit and configured to generate a digital value of a retrieved vector.

In one aspect, a system comprises a key generator configured to generate a key; a memory unit comprising a matrix of in-memory compute units; a plurality of digital-to-analog converters coupled to the key generator and coupled to the memory unit, and configured to convert a digital value of the key to a set of analog signals, each analog signal configured to drive a corresponding row of the matrix; a plurality of analog-to-digital converters coupled to the memory unit and configured to generate a digital value of a retrieved vector; a processing unit including a processing unit memory, and at least one processor, coupled to said processing unit memory, and operative to perform operations comprising: generating the key for each vector of a plurality of vectors to be stored; binding each vector of the plurality of vectors with the corresponding key to create a 2-dimensional distributed representation via an outer product operation; putting the 2-dimensional distributed representation in a superposition with another 2-dimensional distributed representation to create an aggregated 2-dimensional distributed representation; storing the aggregated 2-dimensional distributed representation in the memory unit; requesting a retrieval key corresponding to a requested vector of the plurality of keys; generating the retrieval key corresponding to the requested vector; and using the retrieval key to retrieve the requested vector from the stored aggregated 2-dimensional distributed representation.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
a way to flexibly repurpose in-memory computing tiles as memory arrays with minimal hardware overhead;
closed integration of the key generator as a form of addressing in the tile;
techniques for recovering vectors stored in an in-memory computing tile via a high signal-to-noise (SNR) operation (collective read, matrix-vector multiplication (MVM)), even with the use of low SNR devices and peripheral circuits; and
a collective read that can enable the use of very resistive memory cells, even Tera-ohm-scale (on the order of 1012 ohms), leading to even higher efficiency and higher read out speeds.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is an exemplary representation for encoding vectors to be stored using keys, in accordance with example embodiments;

FIG. 2 is an exemplary workflow for generating a plurality of the representations and for generating a superposition of the plurality of representations to create the final state of the memory, in accordance with example embodiments;

FIG. 3 is a workflow for restoring the vectors from the 2-dimensional distributed representation, in accordance with example embodiments;

FIG. 4 is an exemplary workflow for retrieving vectors from a memory unit that is storing the 2-dimensional distributed representation, in accordance with example embodiments;

FIG. 5 is an exemplary system for storing vectors in an in-memory computing unit, in accordance with example embodiments;

FIG. 6 is a circuit diagram of an exemplary hardware-based key generator, in accordance with exemplary embodiments;

FIG. 7 illustrates a second key generation process, in accordance with exemplary embodiments;

FIG. 8 illustrates a second key generation process, in accordance with exemplary embodiments;

FIG. 9 is a high-level block diagram of an exemplary system incorporating the disclosed techniques, in accordance with exemplary embodiments;

FIG. 10 illustrates the flexible repurposing of analog in-memory computing (AIMC) tiles for embedding table or database storage, in accordance with exemplary embodiments;

FIG. 11 illustrates the compression of DNN weight matrices, in accordance with exemplary embodiments;

FIG. 12 illustrates a training procedure of a DNN to be compressed, in accordance with exemplary embodiments;

FIG. 13 illustrates the use of a delta rule to update the TPR memory matrix, in accordance with exemplary embodiments;

FIG. 14 illustrates the update of the TPR memory Tᵢ₋₁ with the information of a new weight vector wᵢ, in accordance with exemplary embodiments;

FIG. 15 illustrates a method of training the TPR memory directly, in accordance with exemplary embodiments;

FIG. 16 illustrates a block diagram of mixed orthogonal and pseudo-orthogonal key generation circuitry, in accordance with exemplary embodiments;

FIG. 17 depicts a computing environment according to an embodiment of the present invention; and

FIG. 18 is a flow diagram of a design process used in semiconductor design, manufacture, and/or test.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

### Compression

Compression is the process of reducing the size of a file or dataset by encoding information using fewer bits than the original representation. This is achieved by identifying and eliminating redundancies within the data. A pertinent goal is to make data more efficient for storage and transmission without significant loss of information. Compression is widely used across various domains, including:
file storage: reduces the amount of disk space required to store files, allowing more data to be stored on a given medium (examples include ZIP files and compressed backup archives);
web browsing: speeds up loading times by compressing images, text, and other resources before they are transmitted over the Internet (examples include formats like joint photographic experts group (JPEG) formats and portable network graphics (PNG) formats for images and GNU Zip for web pages);
multimedia streaming: enhances the transmission of audio and video files over the internet by compressing them, enabling faster streaming and reduced buffering (common formats include MP3 for audio and moving pictures expert group (MPEG) files for video); and
communication: optimizes the bandwidth usage in communication networks by compressing data before transmission, improving the efficiency of data transfer in emails, instant messaging, and voice over Internet protocol (VOIP) services.

### Deep Neural Networks

Deep neural networks (DNNs) have revolutionized the field of artificial intelligence, transforming how complex problems are approached and enabling groundbreaking advancements across various industries. Inspired by the human brain's architecture, DNNs have unlocked unprecedented potential for innovation, driving significant improvements in technology and fundamentally changing human interaction with the digital world.

The ability of DNNs to learn from vast amounts of data and identify intricate patterns has led to excellent performance in tasks, such as image and speech recognition, natural language processing, and game playing. DNNs have not only surpassed traditional algorithms in accuracy and efficiency but have also opened new frontiers' various industries.

Scaling models, e.g. large language models (LLMs) with billions of parameters, have proven to dramatically enhance their performance and capabilities. By increasing the number of parameters, these models can capture and process more complex patterns and nuances in data, leading to significant improvements in tasks, such as language understanding, translation, and content generation. However, this scaling comes at a cost, resulting in an explosion in memory and computational requirements. Training and deploying these massive models necessitates powerful hardware, extensive computational resources, and optimized algorithms to manage the increased demand. Due to their massive size and complexity, modern DNNs are difficult to run on edge devices like smartphones, Internet-of thing (IoT) devices, and other resource-constrained hardware.

### Compression in Neural Networks

Compression in DNNs is pertinent for reducing model size, improving inference speed, and lowering computational and memory demands, making it feasible to deploy these models on resource-constrained devices. Methods used to compress DNNs include:
quantization: reduces the precision of the network's weights and activations, lowering memory and computational requirements;
post-training quantization (PTQ): converts weights from high precision (e.g., 32-bit floating point) to lower precision (e.g., 8-bit integers) after the model is trained;
quantization-aware training (QAT): incorporates quantization into the training process to minimize accuracy loss by simulating lower precision during training;
pruning: involves removing less significant weights or neurons from the network, reducing its size and complexity;
weight pruning: identifies and removes individual weights that have minimal impact on the network's performance;
neuron pruning: removes entire neurons or filters, typically based on criteria such as the magnitude of weights or their contribution to the output;
knowledge distillation: compresses weights and activations by transferring knowledge from a large, complex model (teacher) to a smaller, simpler model (student) (the student model is trained to mimic the behavior of the teacher model, achieving similar performance with fewer parameters);
low-rank factorization: decomposes weight matrices into products of lower-rank matrices (this reduces the number of parameters and computational complexity while maintaining the network's expressive power);
weight sharing: reduces the number of unique parameters by forcing multiple weights to share the same value (this can be implemented through techniques like vector quantization, where a small set of codebook vectors represents the weight values);
hashednets: reduce the memory footprint of deep neural networks by using a hash function to randomly group network weights and store them in a shared hash table (this method significantly reduces the number of unique parameters, allowing significant compression without substantial loss in accuracy);
sparsity-inducing regularization: introduces regularization terms during training to encourage sparsity in the network's weights (methods include L1 regularization, which penalizes the absolute sum of weights, pushing many of them to zero); and
random offset block embedding (ROBE): a compression technique specifically designed for large scale embedding tables (by dividing a small circular embedding space into blocks with random offsets, ROBE provides embeddings for deep learning recommendation models (DLRMs) with orders of magnitude reduction in memory and computation requirements).

### Conventional Computer Memory

Computer memory is a pertinent component in a computing system, serving as the workspace for data manipulation and storage. A conventional memory is typically organized as a two-dimensional array of cells, each cell storing one or more bits of information, depending on the technology. To read or write data, the system accesses specific cells within this array, achieved by selection of a particular row and a particular column where the desired piece of information is located. The cells usually found in conventional computers are dynamic random-access memory (DRAM) cells, Flash cells, or static random-access memory (SRAM) cells.

### Non-Volatile Memory and Flash

A pertinent differentiation between memory technologies is volatile and non-volatile memories. A volatile memory technology means that the memory devices require power to maintain the stored information (e.g., DRAM and SRAM). Volatile memories are usually associated with fast read and write speeds but are inefficient in storing huge amounts of data due to the data loss when power is off. Additionally, DRAM-based memories require periodic refreshes of the data, further deteriorating the efficiency of the memory unit.

Non-volatile memories (NVM), on the other hand, retain data even when power is turned off. They are considered ideal for long-term storage due to their non-volatility and density but suffer from higher read/write speeds than prominent volatile technologies. For that reason, they tend to be used as solid state hard-drive disks. Flash devices are the most prominent NVM device. They also allow for multi-bit storage of information. As described further herein, one or more embodiments advantageously combine the advantages of non-volatility and energy efficiency of memories like Flash with the speed of volatile memories like SRAM and DRAM (note that, using one or more embodiments, a readout from Flash-based arrays can reach speeds of older generations of DRAMs, but with the energy efficiency of nvm memories. Conventional flash memories not using aspects of the invention are many orders of magnitude slower than DRAM and SRAM memories).

### Emerging Memory Technologies

As memory technology continues to evolve, new memory devices have emerged. Among these, memristors stand out as a significant advancement in the field. A memristor is a type of non-volatile memory (NVM) device (retains information when powered off) whose resistance changes according to electrical stimuli. These devices can store information in their resistance state. Examples of such devices are resistive RAM (RRAM) and phase change memory (PCM).

Memristors usually offer the capability to store multiple bits of information in a single cell (like Flash), increasing the density of the array. Memory arrays with memristors are architected in a similar fashion to conventional arrays, with a selection of a single device typically requiring the activation of single row and column, producing a signal (usually current) sensed by a sense amplifier.

### In-Memory Computing

A memory array can be built to perform MVM operations using memristors in the analog domain. In such arrays, all rows are active and provide the input vector of the operation as Voltages (Vᵢ). All devices in a column are active, contributing a current in the overall bitline current (Iⱼ) that is then digitized using an analog-to-digital converter (ADC). Depending on the technology of the devices, details like the nature of the analog-digital converter (ADC), the way the input stimuli are applied, and the layout of the crossbar are subject to modification(s).

### In-Memory Computing Memory Unit and Conventional Memory Unit

The differences between a conventional memory unit and an in-memory computing unit include:
in a conventional memory unit, only a single row of devices is active at a time; in an in-memory computing unit, multiple rows and columns are active at a time;
in a conventional memory unit, sense amplifiers are used to detect the value of the selected device, while in an in-memory computing unit, an ADC is used to resolve the current of the active devices; and
further array parameters, such as size, wire resistance, and the like, are optimized for the different modes of activation.

With the differences evidenced above, it will be appreciated that a unit architected as an in-memory computing unit cannot act as a conventional memory unit and the other way around, unless a design contains the necessary circuitry for both types of readout. Such a solution would affect performance in either mode, as the array would not be optimized for a single type of mode, and would involve large area overhead.

### Associative Memories and AIMC

AIMC has been proposed as a way to realize associative memories, due to their extreme efficiency in performing MVM operations, that constitutes the unbinding operation in associative memories (in associative memories that require MVM for unbinding).

### Associative Memories and Storage in Superposition

In hyperdimensional space, owing to dimensionality, randomly drawn high-dimensional vectors are quasi-orthogonal with high probability. This property can be exploited to holistically re-arrange the available parameters in a model into a set of K d-dimensional vectors. These K vectors, each after binding with a randomly drawn d-dimensional vector, can be reliably stored in superposition with each other, resulting in a d-dimensional superposed vector that requires almost the same number of parameters as a single vector (d) instead of K×d.

### Reducing the Footprint of DNN Models

The significant increase in the number of parameters in state-of-the-art deep neural networks has, in turn, significantly increased the demand for memory to store the weights and compute to perform the increased operations. This large footprint forces contemporary artificial intelligence (AI) accelerators to contain an enormous amount of DRAM memory, a technology known for its energy consumption, to hold the parameters of the neural network. In some cases, models must be split between multiple compute units just to accommodate the necessary amount of DRAM.

Especially in edge computing environments, where dense memory technologies like DRAM are often unavailable, devices are constrained to using low-parameter networks or relying on cloud services to handle computationally intensive tasks. When memory capacity becomes a limiting factor, compressing DNN models offers a viable solution to reduce the models' footprint. However, this approach may incur costs in terms of:
increased computational load, required for decompression;
reduced accuracy, as compression errors can lead to less precise computation; and
additional training time, to adapt the models in their compressed state.
   Use of the Same Memory Unit for Storage and in-Memory Computing

One or more embodiments advantageously provide a memory unit that can operate both as a computing unit and as a storage unit, without significant degradation of performance on either of these modes of operation; such a unit is architecturally interesting for many applications. Deep neural network accelerators, in particular, would benefit from such a unit, as it enables architecting a system with multiple such units, which can be specialized as memory or compute units depending on the application at hand. For example, for a transformer workload, a set of memory units can be assigned to store the embedding table and the rest to be used as computing units for the layers of the transformer. As the embedding table and the network layer sizes change depending on the model, a mixed-use memory unit provides flexibility on the possible supported models. A mixed use of the same memory unit for computing and storage is difficult to achieve from a hardware perspective, and other solutions are employed in one or more embodiments to obtain a flexible mixed-use memory unit.

Use of an in-Memory Computing Unit for Non-Compute Operations

The use of a specialized in-memory computing tile for operations that are not natively matrix-vector multiply (MVM) operations usually involves the use of a computational tile for its native MVM operation, after transforming a problem such that it requires an MVM operation to be solved. An example of such usage is the use of computing tiles for the realization of similarity search or content-addressable memory operations. No application has been demonstrated in the prior art that enables the use of a computing tile both as a computing element and as a storage element to retrieve stored information. If it were to be argued that the use of a one-hot encoded input for an MVM operation on a tile that stored vectors in its rows can fulfill such a purpose, it would be pertinent to note that an analog-digital converter (ADC) that is designed to resolve currents when all wordlines are active is inevitably limited in resolving the exact value of a current coming from a single active row accurately. Such an operation is what would be called a low signal-to-noise ratio (SNR) operation.

With the advent of three-dimensional (3D) memory technologies, the mixed use of a single tile as a vector storage unit and an in-memory compute unit, assigning a number of tiers for storage and a number for compute (i.e., computational use), provides a way for a very small and tightly integrated processing engine for applications like recommendation machines and generative models that merge large storage needs with a DNN compute workload.

### Illustrative Example

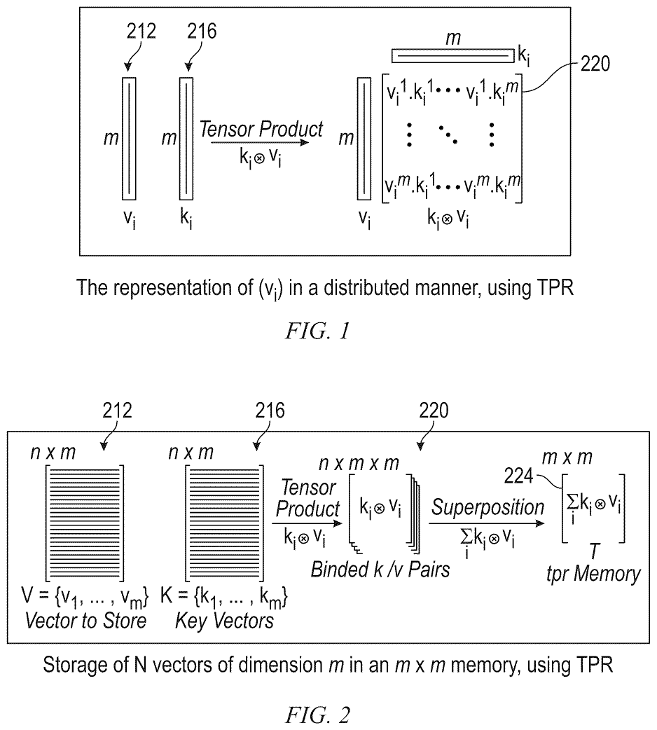

FIG. 1 is an exemplary representation for encoding vectors 212 to be stored using keys 216, in accordance with exemplary embodiments. In the example of FIG. 1, the usage of the exemplary memory unit and the data processing method required to store a set of vectors V 212 in the memory unit are demonstrated. First, the data (vectors 212) is prepared such that it can be stored in a distributed manner. For the example of FIG. 1, this is accomplished using tensor product representation (TPR):

For each vector (vᵢ) 212 to be stored, one key (kᵢ) 216 is drawn. The key 216 used for such applications can be found through an optimization or, to alleviate the need to store the keys 216, generated through an appropriate function. Note that the keys 216 do not have to be the same dimensionality as the value vectors 212.

Each vector 212 is bound with its key 216 to create a 2-dimensional distributed representation 220. This is accomplished via an outer product operation, as illustrated in FIG. 1. The result is the 2-dimensional distributed representation 220, an m×m matrix. The bound representations 220 are then put in a superposition to create the final state of the memory. This is accomplished through the accumulation of a plurality of distributed representations 220 (one for each vector 212 to be stored).

FIG. 2 is an exemplary workflow for generating a plurality of the representations 220 and for generating a superposition of the plurality of representations 220 to create the final state of the memory, in accordance with exemplary embodiments. For example, if there are 1,000 vectors 212 to be stored (based on keys 216 where n=1,000), 1,000 2-dimensional distributed representations (matrices) 220 are produced. If the keys 216 are sufficiently orthogonal, the 2-dimensional distributed representations 220 can be aggregated into one 2-dimensional distributed representation 224. Moreover, if another vector 212 is to be added to the representation 224, the vector 212 can simply be incorporated into the aggregated 2-dimensional distributed representation 224. While the number of vectors 212 may be allowed to exceed the number of available rows of the matrix 220, there will be, however, some interference between the vectors 212 in the 2-dimensional distributed representation 224, which will appear as noise in the data retrieved from storage (in addition to the noise injected by the in-memory compute circuit in which the 2-dimensional distributed representation 224 is stored). Neural network parameters, such as weights, can tolerate the addition of some noise in the retrieved data and, thus, one or more exemplary embodiments are suitable for the storage of neural network parameters (in addition to other types of data). (If n≠m, the usage rate of an m×m memory unit is defined as n/m, which can be ≥1, leading to compression.)

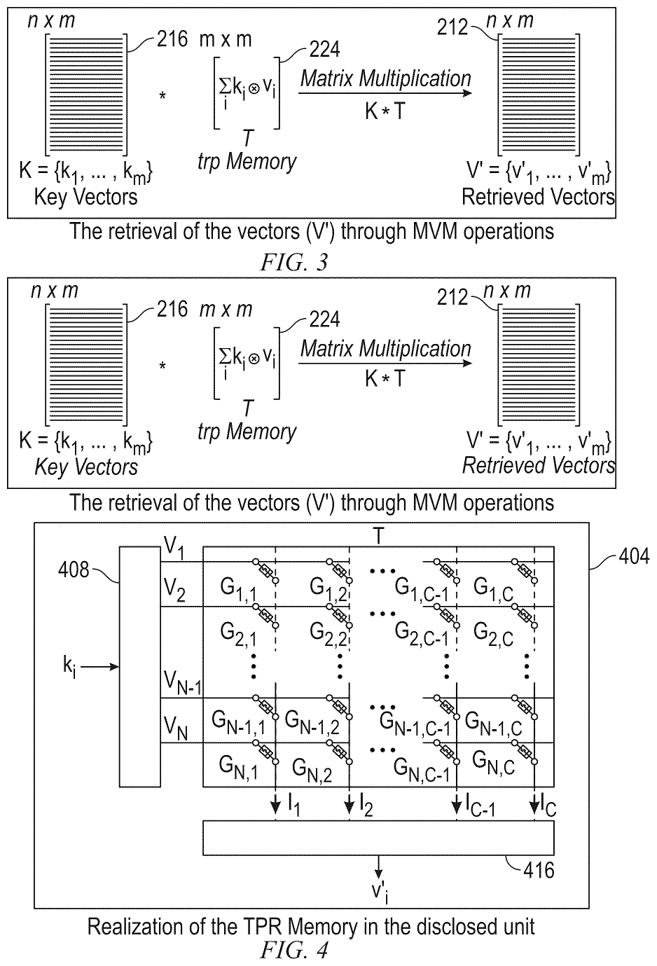

FIG. 3 is a workflow for restoring the vectors 212 from the 2-dimensional distributed representation 224, in accordance with exemplary embodiments. In exemplary embodiments, to read vectors 212 from the compressed TPR memory (the 2-dimensional distributed representation 224), the following process is followed:

the key 216 that was used to bind the requested vector 212 is retrieved and a matrix-vector multiply operation is performed between the key 216 and the compressed memory containing the 2-dimensional distributed representation 224. The result of the operation contains a version of the initially stored vector 212. (The retrieved vector 212 can be a noisy version of the original vector 212.) All of the vectors 212 can be retrieved by performing a matrix-vector multiply operation between each key 216 and the compressed memory containing the 2-dimensional distributed representation 224. The high complexity of the read operation is a pertinent issue in such associative memories.

FIG. 4 is an exemplary workflow for retrieving vectors 212 from a memory unit 404 that is storing the 2-dimensional distributed representation 224, in accordance with exemplary embodiments. Exemplary memory units 404 can be used in this framework as follows:
after the calculation of the TPR memory, the memory array (the 2-dimensional distributed representation 224) is stored in the elements of the memory unit 404;
during readout, the key vector 216 is provided as input to the digital-analog converters 408 and an MVM operation is performed in-memory; and
the output provided in the analog-to-digital converters 416 is the retrieved vector 212 that was requested using the input key 216.

With exemplary memory units 404, this read out operation can be realized efficiently as an MVM operation (with sizes equal to, for example, 512 rows and columns) that can be performed on the order of tens to hundreds of nanoseconds with extremely high power efficiency.

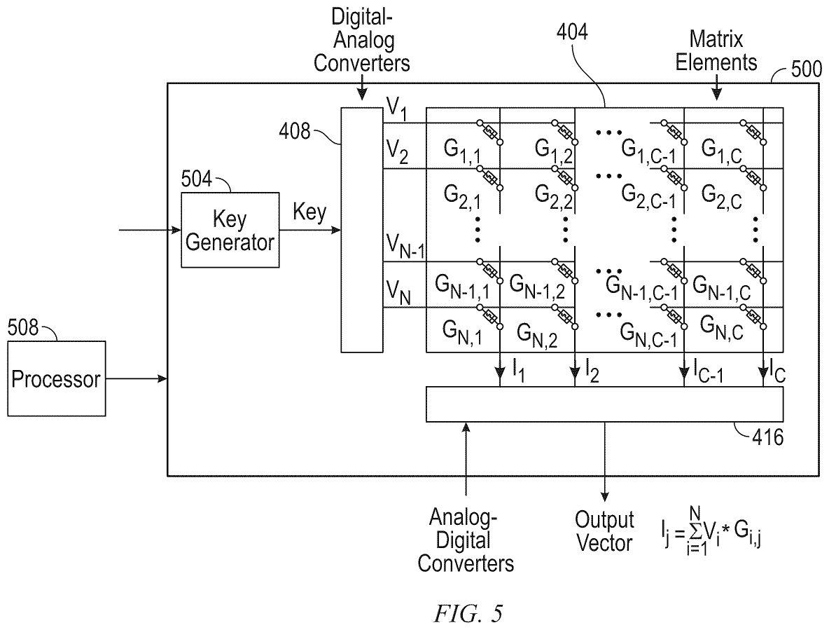

FIG. 5 is an exemplary system for storing vectors in an in-memory computing unit 404, in accordance with an exemplary embodiment. A processor 508 (e.g., using software to implement operations as discussed herein) generates a key 216 for each vector of a plurality of vectors 212 to be stored; binds each vector of the plurality of vectors 212 with the corresponding key 216 to create a 2-dimensional distributed representation 220 via an outer product operation; puts the 2-dimensional distributed representation 220 in a superposition with another 2-dimensional distributed representation 220 to create an aggregated 2-dimensional distributed representation 224; and stores the 2-dimensional distributed representation 224 in the in-memory compute unit 404. A pertinent step to being able to retrieve the information from the in-memory computing unit 404 is the ability to generate the key 216 that corresponds to the desired vector 212. These keys 216 should be able to be generated on the fly, as the need for storing them in memory would incur high overhead and act counter to the purpose of one or more exemplary embodiments. For these reasons, one or more exemplary embodiments adopt an iterative key generator 504 that, in exemplary embodiments, is implemented with hardware. (Note that the key generator 504 uses the same technique to generate keys as the processor 508.) In one or more exemplary embodiments, the operating principles of such a circuit are:
starting from a seed vector, performing in sequence shifting and rotating operations (these are designed to produce unique keys 216 after each iteration); and
the resulting key vector 216 is used as a seed for the generation of the next key 216.

To retrieve a vector from the memory unit 404, a retrieval key 216 corresponding to a requested vector 212 of the plurality of keys 216 is requested from the key generator 504; a retrieval key 216 corresponding to the requested vector 212 is generated; and the retrieval key 216 is used to retrieve the requested vector 212 from the 2-dimensional distributed representation 224 stored in the memory unit 404. Requesting a key 216 corresponding to vector N 212 means that the process is repeated N times to generate the correct key 216. Such iterative key generators have been used in hyperdimensional computing. Given the teachings herein, the skilled artisan will be able to implement embodiments of the invention by adapting known iterative key generator circuits.

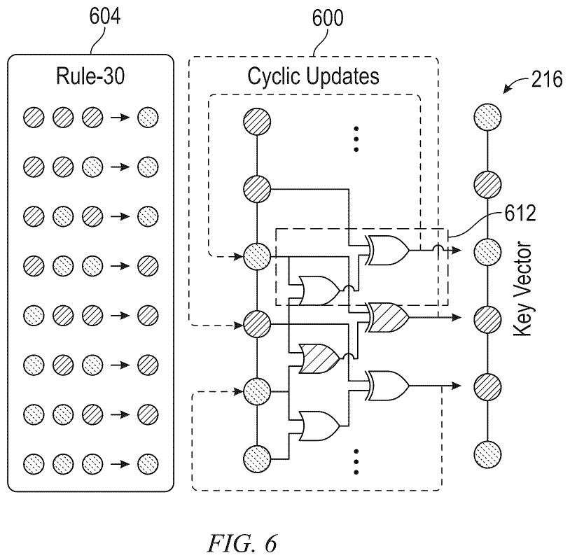

FIG. 6 is a circuit diagram of an exemplary hardware-based key generator 600, in accordance with exemplary embodiments. As illustrated in FIG. 6, the key generator 600 is built from subcircuits 612, where one subcircuit 612 is defined for each bit of the key vector 216 to be generated. In exemplary embodiments, the key generator 600 is based on a rule 30 technique and generates a key 216 on each clock cycle (such as every 1 nanosecond (ns)). (The rule 30 technique is based on a cellular automaton applying rule 30 to deterministically generate pseudo-orthogonal vectors, starting from a random binary seed vector.) Rule 30 defines the next value for each bit of a generated key 216 based on its current value and the current values of the two neighboring bits of the given key 216 (as illustrated in rule base 604 where a solid circle represents a bit with a logical one value and a hollow circle represents a bit with a logical zero value). If a bit does not have two immediate neighbors, a zero can be assigned to the missing neighbor or the value of the neighbor can be obtained using a wraparound representation. The generated keys 216 are not, however, perfectly orthogonal, and thus the values (vectors 212) retrieved after storage will have noise embedded. (If the keys 216 are orthogonal, there will be no embedded noise if the number of vectors is less than or equal to the key dimension.) If truly orthogonal keys are desired, a Hadamard matrix can be used to produce the keys, but this reduces flexibility as non-orthogonal keys are not allowed. (A Hadamard matrix is a matrix specifically built to have all its rows orthogonal to each other. As such, a Hadamard matrix can be constructed and a circuit created to iteratively produce its rows, which are de facto orthogonal. This reduces the flexibility because only up to the dimensionality of the key vector can be stored (there can only be 256 orthogonal vectors with size 256).

### Efficient Key Generation

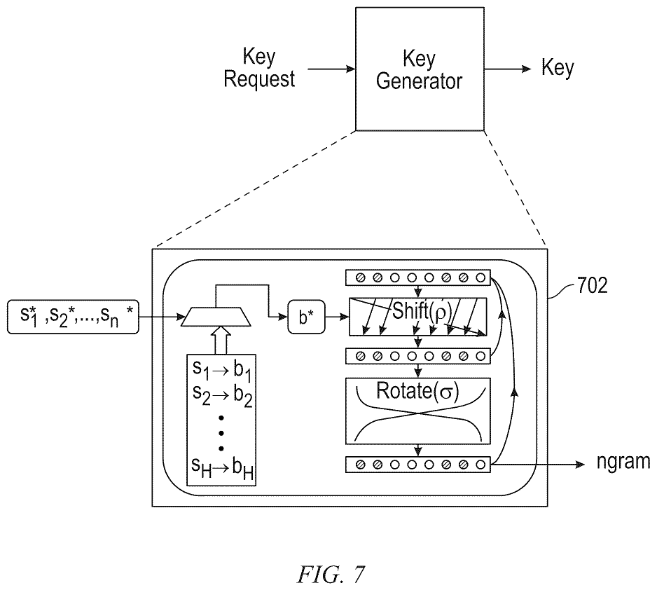

FIG. 7 illustrates a second key generation process 702, in accordance with an exemplary embodiment. In the exemplary embodiment of FIG. 7, a multi-seed system is configured where a vector is iteratively permuted. The seed is the current key vector 216, which is then manipulated to create the next key vector 216. At each iteration, the previous key vector 216 is rotated by an amount to produce an n-gram of itself.

It is known that iterative processes that take a seed vector and serially permute it are effective and inexpensive hardware-wise, but require at most 2^{k} iterations to generate the correct key, considering an index size of k-bits. It is pertinent to note that this kind of key generation may not be a bottleneck in applications where random access is not required, such as the storage of DNN weights. In such cases, after an initial wait, a new key 216 is generated per-iteration.

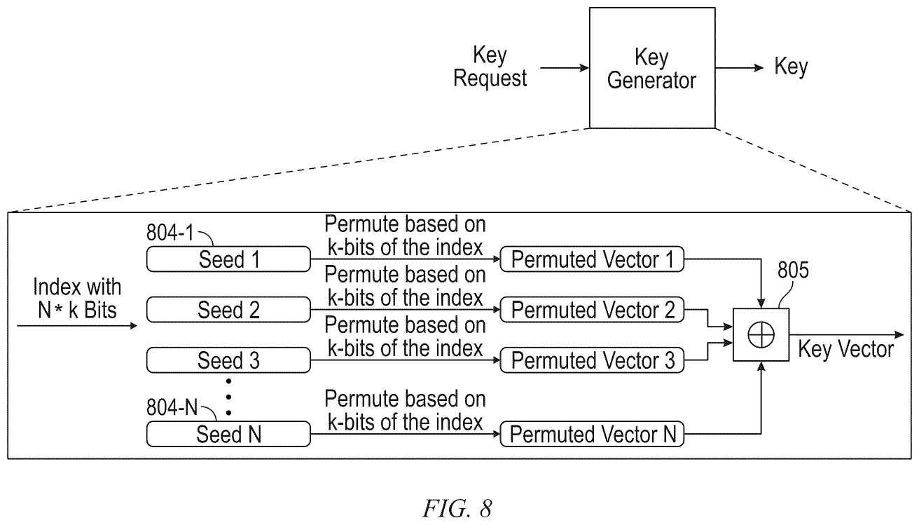

In the case that random access is required, such as when storing an embedding table, a faster key generator would be preferable, especially in extreme superposition where the indices of the vectors 212 stored in a given memory can reach a high number (as the value of k gets larger). In the exemplary embodiment of FIG. 7, a conventional key generator is extended to allow for faster key generation at a cost of more seed keys and hardware resources (see FIG. 8 for exemplary details).

FIG. 8 illustrates a third key generation process, in accordance with an exemplary embodiment. For the case that random access is required, the necessary iterations can be reduced to produce a key 216 by employing multiple parallel seeds 804-1, . . . , 804-N and performing a lesser number of sequential rotations to get to the requested key 216. The combination of all branches could be an XOR operation 805 (see flow diagram of FIG. 8). The key generator described in FIG. 8 accelerates the generation process with a trade off in hardware costs.

An additional way to make a serial key generator more efficient comes from enhancing the ability of its controller. For example, the controller for the key generator can be enhanced with the ability for out-of-order execution or the reorganization of its program so that it can use the sequential nature of the key generation to its maximum potential. For example: consider the example that a program requires the retrieval of vectors 212 with identifiers 1, 18, 15, 3. A conventional controller would execute these instructions sequentially, thus asking the key generator to generate the key vectors 1, 18, 15, 3 with that sequence. As such, the key generator would need to spend 1 cycle to generate the first key 216, 17 to generate the second and then it would need to iterate till the end of its possible values until it can return to 0 and spend 15 cycles to generate the third key 216. The same would apply for the last key 216. Depending on the size of the key generator, this could be detrimental to the operation of the system.

An out-of-order capable controller can advantageously rearrange the requests (if they are indeed independent) so that it requests keys 216 with the sequence 1, 3, 15, 18. In this case the controller would create all keys 216 in 18 cycles, possibly saving a significant amount of time in the process. Note that such a reordering can also be added as a step during compilation, thus adding no hardware overhead.

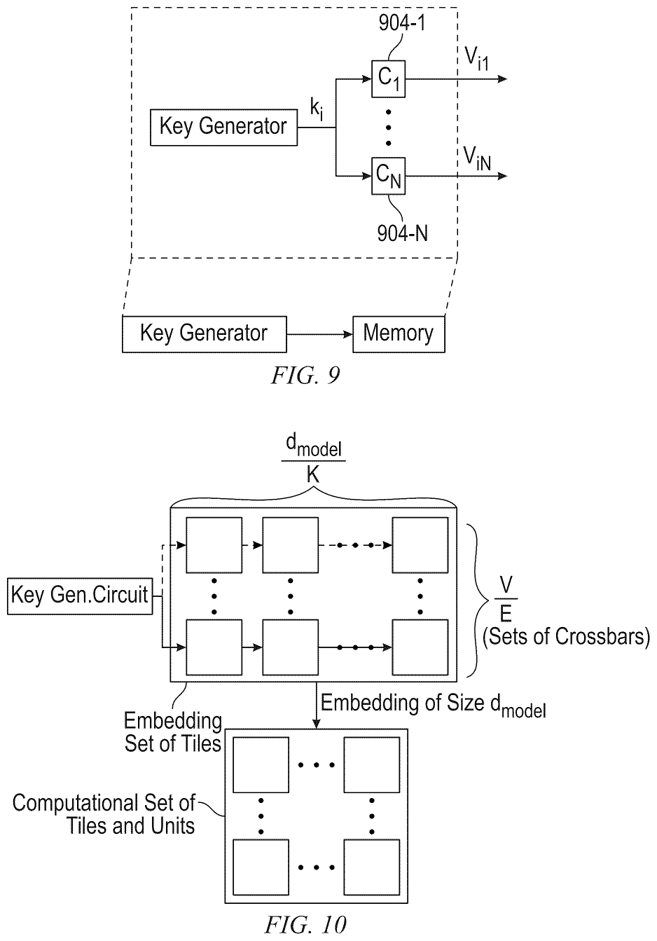

FIG. 9 is a high-level block diagram of an exemplary system incorporating exemplary techniques, in accordance with an exemplary embodiment. The components described in FIG. 4 can be organized in a way to improve the efficiency or performance of the system. In modern systems, a processing unit is increasingly parallelized and can support a slew of incoming data at the same time. Additionally, vectors required for workloads, such as deep learning or scientific computing, have a size larger than the size of a state-of-the-art IMC tile, meaning that multiple queries are required for the retrieval of a single full-sized vector 212. As such, a system can be designed such that a key generator is multiplexed across multiple crossbars (Ci) 904-1, . . . , 904-N. The controller can consider that an instruction can either recover a vector 212 of sizeN*crossbar_dim at once or N vectors 212 of size crossbar_dim as a group. Such an implementation can reduce the redundancy when it comes to the key generator circuit. Additionally, it introduces a favorable trade-off with the complexity of the key generator, as the resources saved from decreasing the number of circuits can be spent on more complex generators (see FIGS. 7 and 8).

### TPR Compression in DNNs

FIG. 10 illustrates the flexible repurposing of analog in-memory computing (AIMC) tiles for embedding table or database storage, in accordance with exemplary embodiment(s). In (large) language models, a pertinent part of the network is the embedding tables. These are large tables that map a token (character, word or syllable) to a vector of dimension model.

In many models, the parameters associated with the embeddings are a large part of the network's overall parameters. The implementation of such embeddings is especially problematic in AIMC systems, as their one-hot nature prohibits their realization in AIMC tiles, requiring an external memory, such as DRAM or Flash. One or more exemplary embodiments, including the implementation of the embodiment of FIG. 9, provide a way to perform embeddings in-memory due to the following:
embeddings, when stored in an associative memory, are recovered with a dense MVM, instead of a one-hot MVM (accordingly, especially suited for AIMC tiles). A single key generator is employed to notify all participating tiles and produce the embedding vector. Due to the proliferation of 3D memory technologies and the miniaturization of devices, the embeddings can be stored extremely densely and very efficiently, without sacrificing performance. An AIMC tile, without any hardware change, can be repurposed from a computational element for a layer to a memory element for embeddings since the key generator circuits are decoupled from the tiles themselves. Such a system and the method to configure it are shown in FIG. 10.

Considering a vocabulary size of V and an embedding dimension of d_{model}, an embedding table in a system including multiple AIMC tiles can be mapped as follows:

Train the network offline with the associative memory transformations to achieve the target performance. Tune the compression factor as dictated by the required performance (compression factors≤1 can still be considered). Post training, the network is robust to the transformations from the embeddings and it is dictated that E tokens should be stored per tile. To map the embedding vectors, the number of tokens (V) and their dimension (d_{model}) are considered. For a crossbar with size

$$K \times K , \frac{V}{E} * \frac{{d}_{model}}{K}$$

crossbars are employed to accommodate both the number of tokens

$$( \frac{V}{E} )$$

and their size

$$( \frac{{d}_{model}}{K} ) .$$

Note that, when it comes to 3D AIMC tiles or multiplexed AIMC tiles that contain mutually exclusive crossbars, the v/E can be mapped in the same area, leaving only

$$\frac{{d}_{model}}{K}$$

distinct tiles. Then the key generation circuit contains two jobs, when given a token number:

First, find in which set of crossbars

$$( out of \frac{V}{E} ) ,$$

the requested embedding resides (top set of arrows in FIG. 10). This search is simple as the mapping is static and the ranges can be stored in simple look-up table (LUT) structures (a LUT that indicates that embeddings 0-N can be found by addressing some specific signals, in this case, the top row of tiles).

Second, generate a key to recover the embedding. Only E distinct keys are necessary, as it is only needed to differentiate between E tokens inside each associative memory, and the key can be shared across all associative memories.

The key is then sent to all

$$\frac{{d}_{model}}{K}$$

crossbars that contain the requested embedding and a parallel MVM happens on all of them. Finally, the token can then be forwarded to the rest of the computational elements, that can be either more AIMC tiles or other computational elements, such as digital processing units. Using that method, any AIMC accelerator can repurpose its tiles to either store embeddings or to act as normal AIMC tiles, providing flexibility in the vocabulary size and the d_{model} of the models that it can support.

### TPR Compression in DNNs

In exemplary embodiments, weight vectors of DNNs are compressed by binding them with a set of Rademacher keys using tensor products (TPR) in superposition to form a compressed TPR memory. (Rademacher keys are binary sequences where each element is independently drawn from a Rademacher distribution, meaning the keys take values of +1 or −1 with equal probability. Their randomness exhibits useful mathematical properties, such as near-orthogonality when used in high-dimensional spaces.) The binding operation of a set of weight vectors can be described as follows:

every weight vector wᵢ in the set W of length n is bound with the corresponding key vector kᵢ by TPR, similar to the binding of vectors 212 (see, FIG. 1). The resulting matrices are added up element-wise (superposition) to form the TPR memory, similar to the superposition illustrated in FIG. 2.

The unbinding operation of a TPR memory can be described as follows:
to unbind the TPR memory T and retrieve the (noisy) weight vectors W′, the TPR memory matrix is multiplied by the key matrix K. This is similar to retrieving all the vectors 212, as illustrated in FIG. 3. The retrieved weight matrix W′ can be described as W+ε, where W is the original weight matrix and ε is the noise term resulting from binding and unbinding the weight vectors.

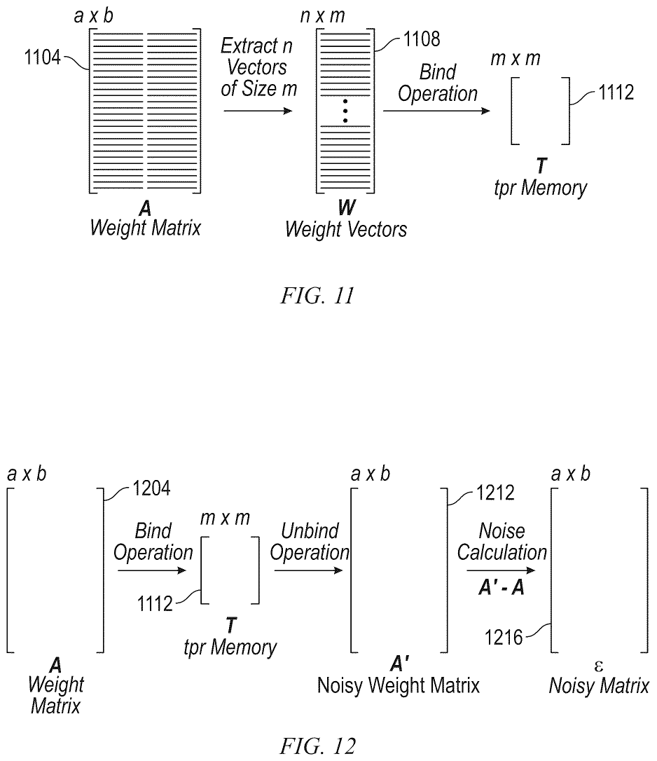

FIG. 11 illustrates the compression of DNN weight matrices, in accordance with exemplary embodiments. The compression of DNN weight matrices can be described as follows:
vectors of the dimension n are extracted from the weight matrix A 1104;
the vectors 1108 are concatenated row-wise to a m×n array W; and
using the binding procedure described above, the weight array W 1108 is bound with an array K including m Rademacher keys of dimension n.

The result is an m×m TPR memory 1112 within which the information of the weight matrix A 1104 is compressed. When unbinding the TPR memory T 1112, noisy weight vectors W′ are recovered, which are reshaped to form the recovered (noisy) weight matrix A′.

FIG. 12 illustrates a training procedure of a DNN to be compressed, in accordance with exemplary embodiments. The training procedure of a DNN to be compressed can be described by the following steps:

before every forward pass, weight matrices A 1204 are compressed and subsequently decompressed by the binding and unbinding methods respectively with m×m TPR memory 1112 (described above) to obtain the noisy weight matrices A′ 1212; and
the noise matrix ε 1216 is calculated by the subtraction A′-A.

The noise ε is added to the weights A 1204 during the forward pass to simulate compression noise. The noisy weights A′ cannot be used directly, since the gradient flows through A.

Improving Superposition with Delta Rule

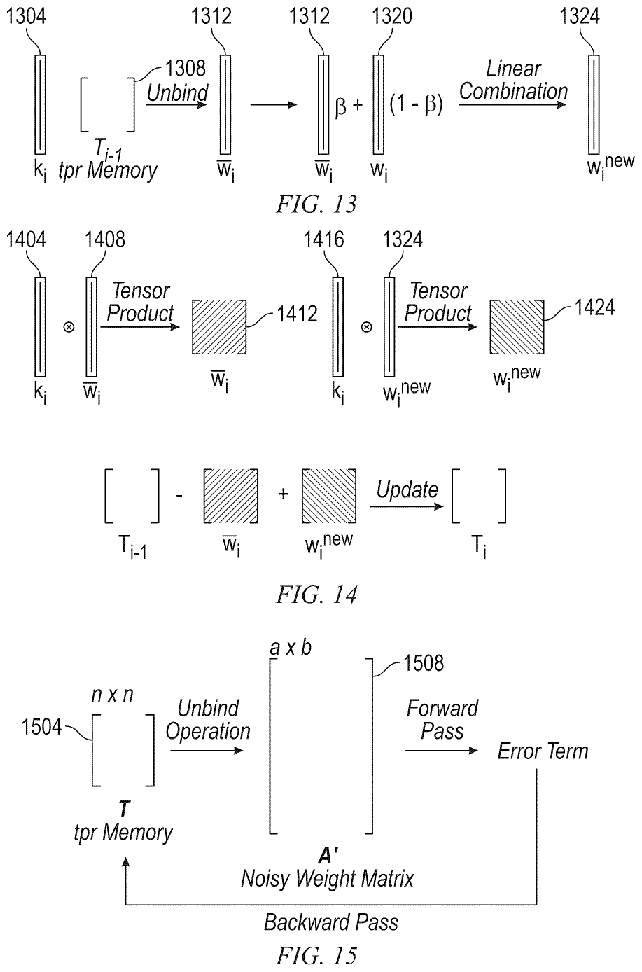

Up to this point, the bound weight tensors were combined by element-wise addition. FIG. 13 illustrates the use of a delta rule to update the TPR memory matrix 1308, in accordance with exemplary embodiments. To update the TPR memory Tᵢ₋₁ 1308 with the information of a new weight vector wᵢ, an exemplary procedure is as follows:
the current state of the TPR memory Tᵢ 1308 is unbound with the new key kᵢ 1304 to yield the vector w̅ᵢ 1312 which can be described as “the part of wᵢ that is already in the TPR memory”; and
the update weight vector

$${w}_{i}^{n e w}$$

1324 is calculated as a linear combination of wᵢ 1320 and w̅ᵢ 1312.

FIG. 14 illustrates the update of the TPR memory Tᵢ₋₁ with the information of a new weight vector wᵢ, in accordance with exemplary embodiments. To update the TPR memory Tᵢ₋₁ with the information of a new weight vector wᵢ, the procedure is as follows:

the vectors w̅ᵢ 1408 and

$${w}_{i}^{n e w}$$

1324 are bound with the key kᵢ 1404, 1416 to obtain the old and new parts of the TPR memory Wᵢ 1412 and

$${W}_{i}^{new}$$

1424.

To update the TPR memory, the old part is subtracted and the new part is added.

### Direct Training of Superposition

Up to this point, the gradient flowed through the weight matrix A. FIG. 15 illustrates a method of training the TPR memory directly, in accordance with exemplary embodiments. The training procedure can be described by the following steps:

during every forward pass, the TPR memory T 1504 is unbound to yield the noisy weight matrix A′ 1508.

In the backward pass, the TPR memory T 1504 (i.e. the bound weight matrix) is updated directly. Therefore the binding operation is omitted completely. (Note: keys could also be learned instead of using Rademacher.)

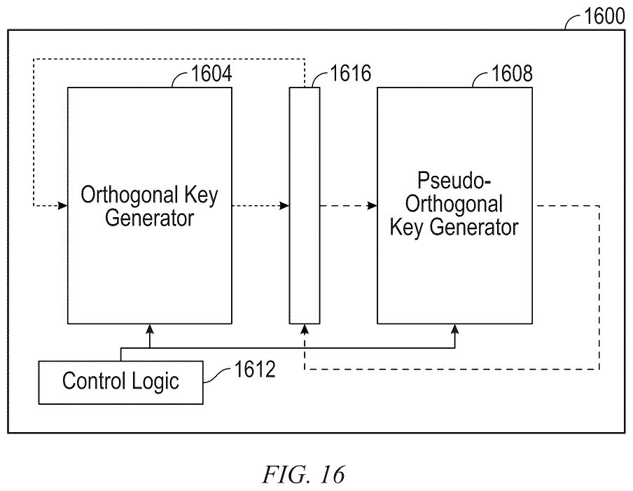

FIG. 16 illustrates a block diagram of mixed orthogonal and pseudo-orthogonal key generation circuitry, in accordance with exemplary embodiments. To reduce the noise embedded in the 2-dimensional distributed representation 220, a circuit 1600 that uses orthogonal keys up to the point of their availability and then uses pseudo-orthogonal keys can be constructed, where the first seed used for the generation of the pseudo-orthogonal keys is the last key from the orthogonal generation. In exemplary embodiments, the key generator 504 (of FIG. 5) includes at least two circuits: an orthogonal key generator circuit 1604 for generating orthogonal keys iteratively and a pseudo-orthogonal key generator circuit 1608 using a pseudo-orthogonal process for generating pseudo-orthogonal keys. The orthogonal key generator circuit 1604 may be implemented, for example, with a Hadamard process.

Control logic 1612 implements the following flow:
if the current iteration is less than or equal to the dimension of the key 216, the orthogonal key generator circuit 1604 is used to generate the next key 216 (dotted path); and
if the current iteration is greater than the dimension of the key 216, then the pseudo-orthogonal key generator circuit 1608 is used for the next key 216 (dashed path).

Intermediate storage 1616 is shared between the orthogonal key generator circuit 1604 and the pseudo-orthogonal key generator circuit 1608, such that there is a continuation of operation when moving from orthogonal key generation to pseudo-orthogonal key generation. During the software preparation of the data, where the binding keys are selected, a corresponding mixed approach should be used.

Given the discussion thus far, it will be appreciated that, in general terms, an exemplary method, according to an aspect of the invention, includes the operations of generating a key 216 for each vector of a plurality of vectors 212 to be stored; binding each vector 212 of the plurality of vectors 212 with the corresponding key 216 to create a 2-dimensional distributed representation 220 via an outer product operation; putting the 2-dimensional distributed representation 220 in a superposition with another 2-dimensional distributed representation 220 to create an aggregated 2-dimensional distributed representation 224; storing the aggregated 2-dimensional distributed representation 224 in an in-memory compute unit 404; requesting a retrieval key 216 corresponding to a requested vector 212 of the plurality of keys 216; generating the retrieval key 216 corresponding to the requested vector 212; and using the retrieval key 216 to retrieve the requested vector 212 from the stored aggregated 2-dimensional distributed representation 224.

In exemplary embodiments, a count of the vectors 212 is allowed to exceed a number of available rows of the 2-dimensional distributed representation 220.

In exemplary embodiments, the vectors 212 represent neural network parameters.

In exemplary embodiments, at least one of the vectors 212 is restored from the stored aggregated 2-dimensional distributed representation 224.

In exemplary embodiments, the at least one restored vector 212 is noisy.

In exemplary embodiments, the retrieval of the requested vector 212 comprises performing a matrix-vector multiply operation between the retrieval key 216 and the aggregated 2-dimensional distributed representation 224 to generate the requested vector 212 and thereby retrieve an approximation of the requested vector 212.

In exemplary embodiments, the performing of the matrix-vector multiply operation includes providing the retrieval key 216 as input to digital-analog converters 408 of an in-memory compute unit 404.

In exemplary embodiments, the requested vector 212 is provided via an analog-to-digital converter 416 of an in-memory compute unit 404.

In exemplary embodiments, the matrix-vector multiply operation between each generated key 216 and the aggregated 2-dimensional distributed representation 224 is repeated to generate a set of the vectors 212.

In exemplary embodiments, a seed vector is obtained; in sequence shifting and rotating operations are performed on the seed vector; and a resulting key vector 216 is used as a seed for a generation of a next key 216.

In exemplary embodiments, the generating of the key 216 is based on a rule 30 technique where a next value for each bit of the generated key 216 is based on a current value of the bit and current values of two neighboring bits of the corresponding bit of the given key 216.

In one aspect, a circuit comprises a key generator 504 configured to generate a key 216; a memory unit 404 comprising a matrix of in-memory compute units and configured to store an aggregated 2-dimensional distributed representation 224 of a plurality of vectors 212; a plurality of digital-to-analog converters 408 coupled to the key generator 504 and coupled to the memory unit 404, and configured to convert a digital value of the key 216 to a set of analog signals, each analog signal configured to drive a corresponding row of the matrix; a plurality of analog-to-digital converters 416 coupled to the memory unit 404 and configured to generate a digital value of a retrieved vector 212.

In exemplary embodiments, the key generator 504 comprises an orthogonal key generator circuit 1604 configured to iteratively generate orthogonal keys 216; a pseudo-orthogonal key generator circuit 1608 configured to generate pseudo-orthogonal keys 216; and control logic 1612 configured to control generation of the orthogonal keys 216 using the orthogonal key generator circuit 1604 in response to a current iteration being less than or equal to a dimension of a corresponding key 216 and configured to control generation of the pseudo-orthogonal keys 216 using the pseudo-orthogonal key generator circuit 1608 in response to the current iteration being greater than the dimension of the corresponding key 216.

In exemplary embodiments, the memory unit 404 is configured to store a plurality of neural network parameters.

In exemplary embodiments, the key generator 504 is configured to obtain a seed vector; perform in sequence shifting and rotating operations on the seed vector; and use a resulting key vector 216 as a seed for a generation of a next key 216.

In exemplary embodiments, the key generator 504 is configured to generate the keys 216 based on a rule 30 technique where a next value for each bit of the generated key 216 is based on a current value of the bit and current values of two neighboring bits of the corresponding bit of the given key 216.

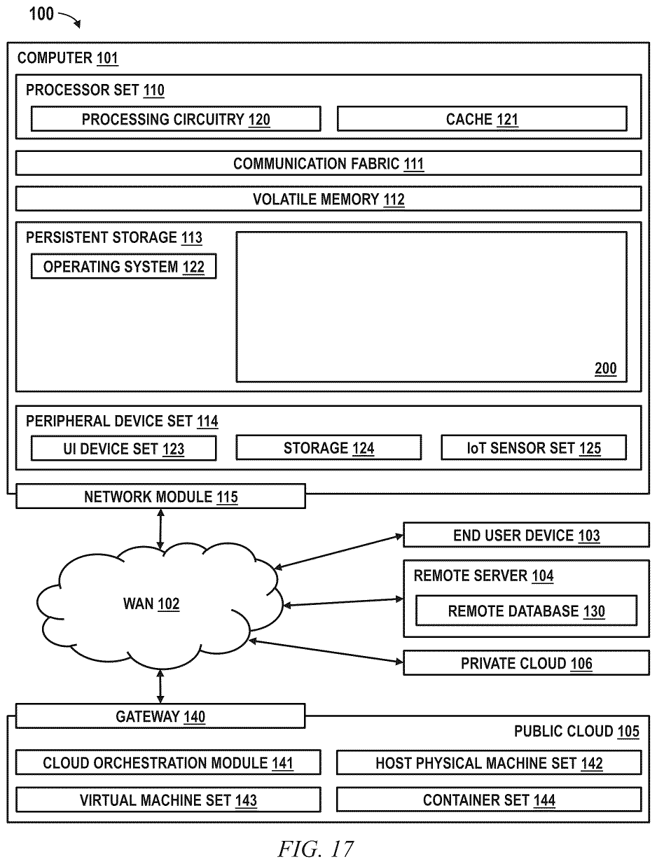

In one aspect, a system comprises a key generator 504 configured to generate a key 216; a memory unit 404 comprising a matrix of in-memory compute units; a plurality of digital-to-analog converters 408 coupled to the key generator 504 and coupled to the memory unit 404, and configured to convert a digital value of the key 216 to a set of analog signals, each analog signal configured to drive a corresponding row of the matrix; a plurality of analog-to-digital converters 416 coupled to the memory unit 404 and configured to generate a digital value of a retrieved vector 212; a processing unit 508 (see, e.g., FIG. 17) including a processing unit memory, and at least one processor, coupled to said processing unit memory, and operative to perform operations comprising: generating the key 216 for each vector of a plurality of vectors 212 to be stored; binding each vector 212 of the plurality of vectors 212 with the corresponding key 216 to create a 2-dimensional distributed representation 220 via an outer product operation; putting the 2-dimensional distributed representation 220 in a superposition with another 2-dimensional distributed representation 220 to create an aggregated 2-dimensional distributed representation 224; storing the aggregated 2-dimensional distributed representation 224 in the memory unit 404; requesting a retrieval key 216 corresponding to a requested vector 212 of the plurality of keys 216; generating the retrieval key 216 corresponding to the requested vector 212; and using the retrieval key 216 to retrieve the requested vector 212 from the stored aggregated 2-dimensional distributed representation 224.

Refer now to FIG. 17.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

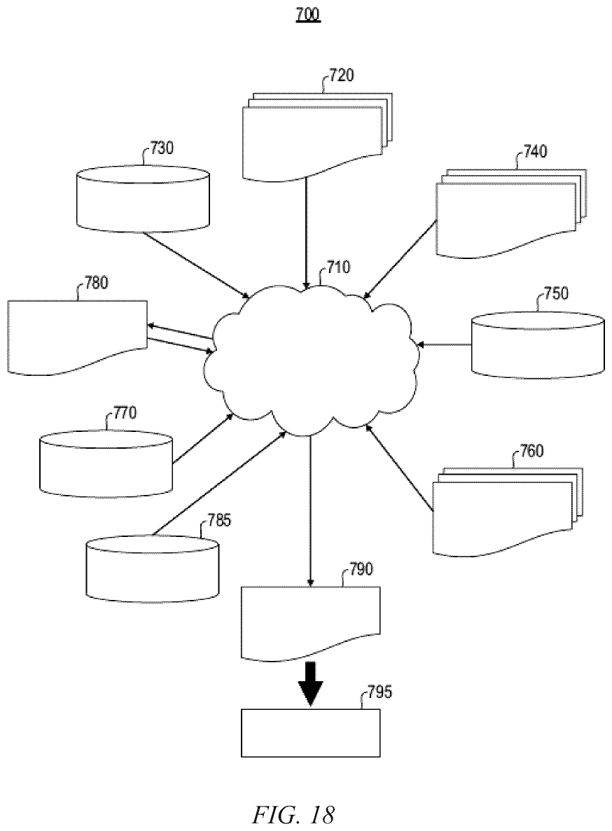

Computing environment 100 contains an example of an environment for the execution of at least some of the computer code involved in performing the inventive methods, such as at least a portion of a system (see blocks 200 and 508) for key generation and/or data compression as described herein, and/or software for semiconductor design and/or control of semiconductor fabrication (see FIG. 18). In exemplary embodiments, the semiconductor design and/or fabrication can be sued to design and/or fabricate the digital-to-analog converters 408, the analog-to-digital converters 416, the key generator 504 and the matrix of in-memory compute units.) In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Exemplary Design Process Used in Semiconductor Design, Manufacture, and/or Test

One or more embodiments make use of computer-aided semiconductor integrated circuit design simulation, test, layout, and/or manufacture. In this regard, FIG. 18 shows a block diagram of an exemplary design flow 700 used for example, in semiconductor IC logic design, simulation, test, layout, and manufacture. Design flow 700 includes processes, machines and/or mechanisms for processing design structures or devices to generate logically or otherwise functionally equivalent representations of design structures and/or devices, such as those that can be analyzed using techniques disclosed herein or the like. The design structures processed and/or generated by design flow 700 may be encoded on machine-readable storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 700 may vary depending on the type of representation being designed. For example, a design flow 700 for building an application specific IC (ASIC) may differ from a design flow 700 for designing a standard component or from a design flow 700 for instantiating the design into a programmable array, for example a programmable gate array (PGA) or a field programmable gate array (FPGA) offered by Altera® Inc. or Xilinx® Inc.

FIG. 18 illustrates multiple such design structures including an input design structure 720 that is preferably processed by a design process 710. Design structure 720 may be a logical simulation design structure generated and processed by design process 710 to produce a logically equivalent functional representation of a hardware device. Design structure 720 may also or alternatively comprise data and/or program instructions that when processed by design process 710, generate a functional representation of the physical structure of a hardware device. Whether representing functional and/or structural design features, design structure 720 may be generated using electronic computer-aided design (ECAD) such as implemented i by a core developer/designer. When encoded on a gate array or storage medium or the like, design structure 720 may be accessed and processed by one or more hardware and/or software modules within design process 710 to simulate or otherwise functionally represent an electronic component, circuit, electronic or logic module, apparatus, device, or system. As such, design structure 720 may comprise files or other data structures including human and/or machine-readable source code, compiled structures, and computer executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 710 preferably employs and incorporates hardware and/or software modules for synthesizing, translating, or otherwise processing a design/simulation functional equivalent of components, circuits, devices, or logic structures to generate a Netlist 780 which may contain design structures such as design structure 720. Netlist 780 may comprise, for example, compiled or otherwise processed data structures representing a list of wires, discrete components, logic gates, control circuits, I/O devices, models, etc. that describes the connections to other elements and circuits in an integrated circuit design. Netlist 780 may be synthesized using an iterative process in which netlist 780 is resynthesized one or more times depending on design specifications and parameters for the device. As with other design structure types described herein, netlist 780 may be recorded on a machine-readable data storage medium or programmed into a programmable gate array. The medium may be a nonvolatile storage medium such as a magnetic or optical disk drive, a programmable gate array, a compact flash, or other flash memory. Additionally, or in the alternative, the medium may be a system or cache memory, buffer space, or other suitable memory.

Design process 710 may include hardware and software modules for processing a variety of input data structure types including Netlist 780. Such data structure types may reside, for example, within library elements 730 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 740, characterization data 750, verification data 760, design rules 770, and test data files 785 which may include input test patterns, output test results, and other testing information. Design process 710 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 710 without deviating from the scope and spirit of the invention. Design process 710 may also include modules for performing standard circuit design processes such as timing analysis, verification, design rule checking, place and route operations, etc.

Design process 710 employs and incorporates logic and physical design tools such as HDL compilers and simulation model build tools to process design structure 720 together with some or all of the depicted supporting data structures along with any additional mechanical design or data (if applicable), to generate a second design structure 790. Design structure 790 resides on a storage medium or programmable gate array in a data format used for the exchange of data of mechanical devices and structures (e.g. information stored in an IGES, DXF, Parasolid XT, JT, DRG, or any other suitable format for storing or rendering such mechanical design structures). Similar to design structure 720, design structure 790 preferably comprises one or more files, data structures, or other computer-encoded data or instructions that reside on data storage media and that when processed by an ECAD system generate a logically or otherwise functionally equivalent form of one or more IC designs or the like. In one embodiment, design structure 790 may comprise a compiled, executable HDL simulation model that functionally simulates the devices to be analyzed.

Design structure 790 may also employ a data format used for the exchange of layout data of integrated circuits and/or symbolic data format (e.g. information stored in a GDSII (GDS2), GL1, OASIS, map files, or any other suitable format for storing such design data structures). Design structure 790 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described herein (e.g., .lib files). Design structure 790 may then proceed to a stage 795 where, for example, design structure 790: proceeds to tape-out, is released to manufacturing, is released to a mask house, is sent to another design house, is sent back to the customer, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating a key for each vector of a plurality of vectors to be stored;
binding each vector of the plurality of vectors with a corresponding key to create a 2-dimensional distributed representation via an outer product operation;
putting the 2-dimensional distributed representation in a superposition with another 2-dimensional distributed representation to create an aggregated 2-dimensional distributed representation;
storing the aggregated 2-dimensional distributed representation in an in-memory compute unit;
requesting a retrieval key of the plurality of keys corresponding to a requested vector;
generating the retrieval key corresponding to the requested vector; and
using the retrieval key to retrieve the requested vector from the stored aggregated 2-dimensional distributed representation.

2. The method of claim 1, wherein a count of the vectors is allowed to exceed a number of available rows of the 2-dimensional distributed representation.

3. The method of claim 1, wherein the vectors represent neural network parameters.

4. The method of claim 1, further comprising restoring at least one of the vectors from the stored aggregated 2-dimensional distributed representation.

5. The method of claim 4, wherein the at least one restored vector is noisy.

6. The method of claim 1, wherein the retrieval of the requested vector comprises performing a matrix-vector multiply operation between the retrieval key and the aggregated 2-dimensional distributed representation to generate the requested vector and thereby retrieve an approximation of the requested vector.

7. The method of claim 6, wherein the performing of the matrix-vector multiply operation includes providing the retrieval key as input to digital-analog converters of an in-memory compute unit.

8. The method of claim 6, wherein the requested vector is provided via an analog-to-digital converter of an in-memory compute unit.

9. The method of claim 6, further comprising repeating the matrix-vector multiply operation between each generated key and the aggregated 2-dimensional distributed representation to generate a set of the vectors.

10. The method of claim 1, further comprising:
obtaining a seed vector;
performing in sequence shifting and rotating operations on the seed vector; and
using a resulting key vector as a seed for a generation of a next key.

11. The method of claim 1, wherein the generating of the key is based on a rule 30 technique where a next value for each bit of the generated key is based on a current value of the bit and current values of two neighboring bits of a corresponding bit of the key.

12. A circuit comprising:
a key generator configured to generate a key;
a memory unit comprising a matrix of in-memory compute units and configured to store an aggregated 2-dimensional distributed representation of a plurality of vectors;
a plurality of digital-to-analog converters coupled to the key generator and coupled to the memory unit, and configured to convert a digital value of the key to a set of analog signals, each analog signal configured to drive a corresponding row of the matrix;
a plurality of analog-to-digital converters coupled to the memory unit and configured to generate a digital value of a retrieved vector.

13. The circuit of claim 12, wherein the key generator comprises:
an orthogonal key generator circuit configured to iteratively generate orthogonal keys;
a pseudo-orthogonal key generator circuit configured to generate pseudo-orthogonal keys; and
control logic configured to control generation of the orthogonal keys using the orthogonal key generator circuit in response to a current iteration being less than or equal to a dimension of a corresponding key and configured to control generation of the pseudo-orthogonal keys using the pseudo-orthogonal key generator circuit in response to the current iteration being greater than the dimension of the corresponding key.

14. The circuit of claim 12, wherein the memory unit is configured to store a plurality of neural network parameters.

15. The circuit of claim 12, wherein the key generator is configured to:
obtain a seed vector;
perform in sequence shifting and rotating operations on the seed vector; and
use a resulting key vector as a seed for a generation of a next key.

16. The circuit of claim 12, wherein the key generator is configured to generate the keys based on a rule 30 technique where a next value for each bit of the generated key is based on a current value of the bit and current values of two neighboring bits of a corresponding bit of the key.

17. A system comprising:
a key generator configured to generate a key;
a memory unit comprising a matrix of in-memory compute units;
a plurality of digital-to-analog converters coupled to the key generator and coupled to the memory unit, and configured to convert a digital value of the key to a set of analog signals, each analog signal configured to drive a corresponding row of the matrix;
a plurality of analog-to-digital converters coupled to the memory unit and configured to generate a digital value of a retrieved vector; and
a processing unit including a processing unit memory, and at least one processor, coupled to said processing unit memory, and operative to perform operations comprising:
generating the key for each vector of a plurality of vectors to be stored;
binding each vector of the plurality of vectors with the corresponding key to create a 2-dimensional distributed representation via an outer product operation;
putting the 2-dimensional distributed representation in a superposition with another 2-dimensional distributed representation to create an aggregated 2-dimensional distributed representation;
storing the aggregated 2-dimensional distributed representation in the memory unit;
requesting a retrieval key corresponding to a requested vector of the plurality of keys;
generating the retrieval key corresponding to the requested vector; and
using the retrieval key to retrieve the requested vector from the stored aggregated 2-dimensional distributed representation.

18. The system of claim 17, the operations further comprising repeating a matrix-vector multiply operation between each generated key and the 2-dimensional distributed representation to generate a set of the vectors.

19. The system of claim 17, wherein a count of the vectors is allowed to exceed a number of available rows of the 2-dimensional distributed representation.

20. The system of claim 17, wherein the generating of the key is based on a rule 30 technique where a next value for each bit of the generated key is based on a current value of the bit and current values of two neighboring bits of a corresponding bit of the key.
